(19) United States
(12) Patent Application Publication
(10) Pub. No.: US 2024/0383446 A1
(43) Pub. Date: Nov. 21, 2024

(54) SYSTEM FOR CLEANING A DETECTIN SURFACE OF A SENSOR

(71) Applicant: VALEO SYSTEMES D'ESSUYAGE, LE MESNIL SAINT DENIS (FR)

(72) Inventors: Frederic BRETAGNOL, La Verriere (FR); Radu-george BUTE, Bietigheim-Bissingen (FR)

(73) Assignee: VALEO SYSTEMES D'ESSUYAGE, La Verriere (FR)

(21) Appl. No.: 18/577,488

(22) PCT Filed: Jul. 5, 2022
(86) PCT No.: PCT/EP2022/068649

§ 371 Date: Jan. 8, 2024

(30) Foreign Application Priority Data
Jul. 7, 2021 (FR) FR2107367

(51) Int. Cl. B60S 1/56; B60S 1/52

(52) U.S. Cl. CPC B60S 1/56; B60S 1/52

(57) ABSTRACT

The invention relates to a cleaning system for cleaning a detection surface of a sensor. The cleaning system includes a cleaning device with a plurality of nozzles, which are configured to deposit droplets of liquid on an acceleration surface situated upstream of the detection surface, a reservoir connected to the cleaning device and configured to store the liquid, and an acceleration device that accelerates the movement of the droplets of liquid from the acceleration surface onto the detection surface.

### TECHNICAL FIELD

The present invention relates to a system for cleaning a detection surface of a sensor for a vehicle. It is applicable in particular, but without limitation, in the field of vehicles or in the field of building.

### BACKGROUND OF THE INVENTION

It is known to those skilled in the art to have a system for cleaning a detection surface of a sensor for a vehicle, said system comprising an air flow-projection device which projects an air flow onto the detection surface of said sensor in order to remove obstructing elements located on said detection surface that obstruct and disrupt the field of view of said sensor and to thus clean said detection surface of said obstructing elements. These obstructing elements are water droplets or dirt. The detection surface is the surface located in the field of view of the sensor.

A drawback of this prior art is that the cleaning system is not effective if the dirt or water droplets are small. They are too difficult to remove with the air flow, unless there is a very powerful air flow-projection device, but this then becomes too bulky and too expensive.

The present invention aims to propose a system for cleaning a detection surface of a sensor for a vehicle, said system making it possible to clean the detection surface of a sensor for a vehicle in an effective manner.

### BRIEF SUMMARY OF THE INVENTION

To this end, the invention proposes a system for cleaning a detection surface of a sensor, characterized in that said cleaning system comprises:
a cleaning device comprising a plurality of nozzles configured to deposit droplets of liquid on an acceleration surface situated upstream of said detection surface,
a tank connected to said cleaning device and configured to store said liquid,
a device for accelerating the movement of said droplets of liquid from said acceleration surface onto said detection surface.

The use of droplets of liquid to clean the detection surface of the sensor and the acceleration of these droplets of liquid makes it possible to have a sufficient amount of kinetic energy to entrain the obstructing elements that are on the detection surface of the sensor, and to thus discharge them from said detection surface such that the latter is clean, and to do so irrespective of the size of said obstructing elements.

According to non-limiting embodiments, said cleaning method may further comprise one or more of the following additional features, taken alone or in any technically possible combination.

According to one non-limiting embodiment, said detection surface and said acceleration surface form part of said sensor, or
said detection surface and said acceleration surface do not form part of said sensor.

According to one non-limiting embodiment, said droplets have a volume of between 2 μL and 50 μL.

According to one non-limiting embodiment, the liquid has a surface tension greater than a surface tension of said detection surface.

According to one non-limiting embodiment, said nozzles are spaced apart from one another such that said droplets form a water front.

According to one non-limiting embodiment, said detection surface and said acceleration surface are on the same plane.

According to one non-limiting embodiment, said cleaning device further comprises a perforated bar connected on one side to said nozzles and on another side to said tank.

According to one non-limiting embodiment, said cleaning device further comprises a support element for said perforated bar.

According to one non-limiting embodiment, a portion of the detection surface is partially coincident with a portion of the acceleration surface.

According to one non-limiting embodiment, said acceleration device is:
an air flow-projection device, or
a device composed of a grid of electrodes that is configured to be passed through by an electrical current, or
a device configured to create a Leidenfrost effect, or
a device configured to synthesize an ultrasonic wave propagating in the acceleration surface, or
a device composed of particles of different polarities.

According to one non-limiting embodiment, the device configured to synthesize an ultrasonic wave propagating in the acceleration surface comprises at least one wave transducer acoustically coupled to the acceleration surface.

According to one non-limiting embodiment, the surface tension of the liquid is 78 mJ/m2 and the surface tension of the detection surface is 20 mJ/m2.

According to one non-limiting embodiment, said nozzles have a diameter of between 1 and 6 mm.

According to one non-limiting embodiment, said nozzles are spaced apart by a distance equal to the diameter of the droplets+−10%.

According to one non-limiting embodiment, said nozzles are disposed at a distance from the acceleration surface of between 0 and 100% of the diameter of the droplets.

According to one non-limiting embodiment, said detection surface and said acceleration surface are inclined by an angle of inclination greater than 20°.

According to one non-limiting embodiment, said nozzles are configured to deposit a droplet at a pressure of less than or equal to 0.5 bar.

According to one non-limiting embodiment, said cleaning device further comprises a protruding element for said bar, configured to protect said acceleration surface.

According to one non-limiting embodiment, said support element is also configured to receive said acceleration device.

According to one non-limiting embodiment, said cleaning device further comprises a distributor for distributing water to said nozzles.

According to one non-limiting embodiment, said water distributor is disposed between two sets of nozzles distributed in a symmetrical manner on either side of said water distributor.

An assembly comprising a detection surface of a sensor and the cleaning system, as described above, is proposed.

According to one non-limiting embodiment, said detection surface and said acceleration surface form part of said sensor, or
said detection surface and said acceleration surface do not form part of said sensor.

According to one non-limiting embodiment, a portion of the detection surface is partially coincident with a portion of the acceleration surface.

According to one non-limiting embodiment, said sensor is an optical sensor.

According to one non-limiting embodiment, said sensor is a vehicle sensor.

According to one non-limiting embodiment, said sensor is a radar, a lidar or a camera.

According to one non-limiting embodiment, said sensor is a building sensor.

According to one non-limiting embodiment, said sensor is a solar panel or a photovoltaic panel.

A method for cleaning a detection surface of a sensor for a vehicle is also proposed, characterized in that said cleaning method comprises the steps:
depositing droplets of liquid on an acceleration surface of said sensor, said acceleration surface being situated upstream of said detection surface, by means of a plurality of nozzles of a cleaning device,
accelerating the movement of said droplets of liquid from said acceleration surface onto said detection surface by means of an acceleration device.

### BRIEF DESCRIPTION OF THE DRAWINGS

The invention and its various applications will be better understood on reading the following description and on examining the figures accompanying it:

FIG. 1 is a figure of a system for cleaning a detection surface of a sensor, said cleaning system comprising a cleaning device, a tank and an acceleration device, according to one non-limiting embodiment of the invention,

FIG. 2 is a perspective view of an assembly comprising a detection surface of a sensor and the cleaning device of the cleaning system in FIG. 1, according to one non-limiting embodiment,

FIG. 3 is a profile view of the cleaning device of the cleaning system in FIG. 2, according to one non-limiting embodiment,

FIG. 4 is a bottom view of the cleaning device of the cleaning system in FIG. 2, according to one non-limiting embodiment,

FIG. 5 is a first zoomed-in depiction of part of the cleaning device in FIG. 2, according to one non-limiting embodiment,

FIG. 6 is an enlarged view of part of the first zoomed-in depiction in FIG. 3, according to one non-limiting embodiment,

FIG. 7 is a perspective view of the cleaning device of the cleaning system in FIG. 2, without a support element, according to one non-limiting embodiment,

FIG. 8 is a sectional view of the cleaning device of the cleaning system in FIG. 7, according to one non-limiting embodiment,

FIG. 9 is a perspective view of a support element of the cleaning device of the cleaning system in FIG. 2, according to one non-limiting embodiment, and

FIG. 10 is a flow diagram of a method for cleaning a detection surface of a sensor, implemented by the cleaning system in FIG. 1, according to one non-limiting embodiment.

### DETAILED DESCRIPTION OF THE INVENTION

Elements that are identical in terms of structure or function and that appear in various figures retain the same references, unless indicated otherwise.

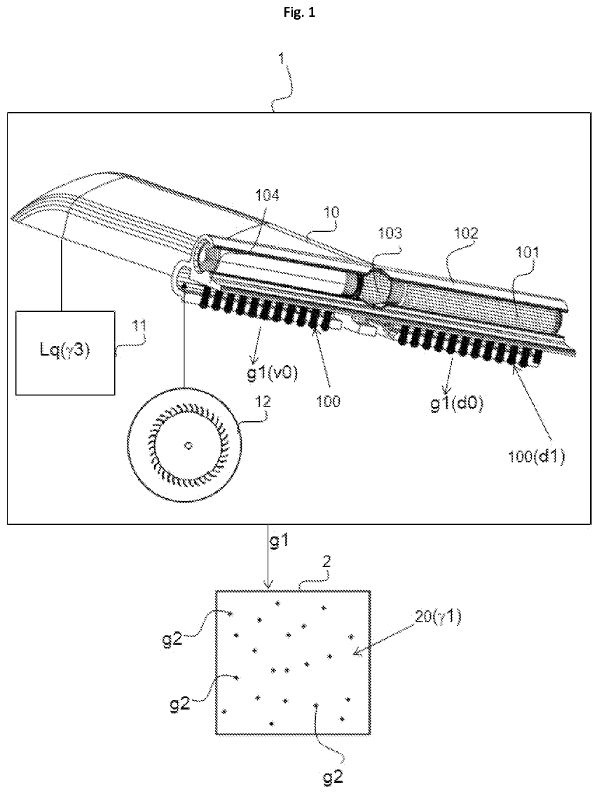

The system 1 for cleaning a detection surface 20 of a sensor 2 according to the invention is described with reference to FIGS. 1 to 9 according to non-limiting embodiments.

The sensor 2 is configured to perform a detection function. It comprises a field of view, otherwise referred to as field of detection.

In one non-limiting embodiment, the sensor 2 is an optical sensor.

In non-limiting embodiment variants, the sensor 2 is a lidar, a radar or a camera. In this case, the sensor 2 is configured to detect static or dynamic objects. In the case of a radar, the radar is a sensor configured to emit radar waves and to receive return radar waves. In the case of a lidar, the lidar is a sensor configured to emit an emitted laser beam and to receive return waves. In the case of a camera, the camera is configured to capture electromagnetic radiation (IR, visible, UV).

In other non-limiting embodiment variants, the sensor 2 is a solar panel or a photovoltaic panel. In this case, the sensor 2 is configured to detect and capture solar energy.

In one non-limiting embodiment, the sensor 2 is a vehicle sensor. In one non-limiting embodiment, the vehicle is a motor vehicle. Motor vehicle means any type of motorized vehicle. In one non-limiting embodiment, when the sensor 2 is a vehicle sensor, and when it is a camera, the camera is disposed behind the rear windshield of the vehicle toward the top of said windshield. In another non-limiting embodiment, the sensor 2 is a building sensor.

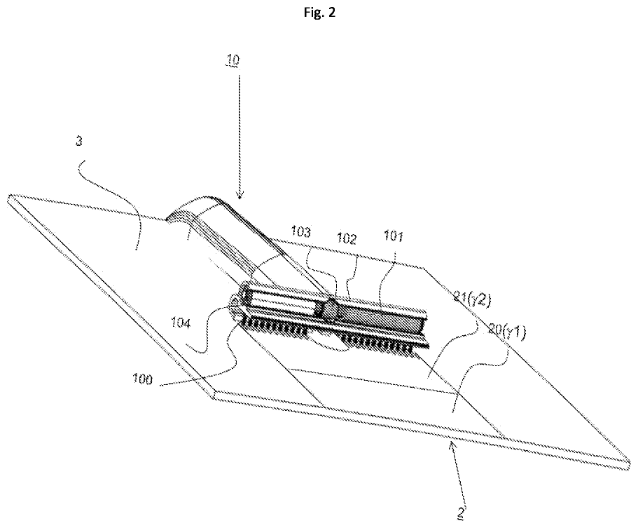

As illustrated in FIG. 1 and FIG. 2, there is a detection surface 20 of the sensor 2. The detection surface 20 is the surface by means of which the sensor 2 performs its detection function. The detection surface 20 is thus the surface located in the field of view of the sensor 2. It thus covers said field of view. For example, in the case of the radar, this means that the detection surface 20 is passed through by the emitted radar waves and the return radar waves. For example, in the case of the lidar, this means that the detection surface 20 is passed through by the laser beam and the return waves. As will be seen below, the detection surface 20 is either associated with the sensor 2 or it forms part of the sensor 2.

The detection surface 20 is the surface that must be cleaned when it is covered by elements g2 which obstruct the field of view of the sensor 2 and therefore the latter is unable to correctly perform its detection function. Such elements g2 are otherwise referred to as obstructing elements g2. In non-limiting exemplary embodiments, the obstructing elements g2 are water droplets or dirt. The water droplets are water droplets originating from rain or fog. These water droplets or dirt are often static on the detection surface 20.

The detection surface 20 is otherwise referred to as the surface to be cleaned 20. In one non-limiting example, the surface to be cleaned 20 is between 50 mm and 300 mm. This is the case for example for a vehicle sensor 2 such as a camera. In one non-limiting example, the surface to be cleaned 20 is between 500 mm and 1500 mm in length and width. This is the case for example for a building sensor 2 such as a solar collector or photovoltaic sensor.

As illustrated in FIG. 1, the cleaning system 1 comprises:
a cleaning device 10,
a tank 11,
an acceleration device 12.

The elements of the cleaning system 1 are described in detail below.

The tank 11 of the cleaning system 1 is described in detail below.

As illustrated in FIG. 1, the tank 11 is connected to said cleaning device 10 and is configured to store a cleaning liquid Lq, otherwise referred to as liquid Lq. In one non-limiting example, the liquid Lq is water. In one non-limiting embodiment, the liquid is a superhydrophobic liquid. In one non-limiting embodiment, the liquid Lq has a surface tension γ3 greater than a surface tension γ1 of said detection surface 20 and far from said surface tension γ1. This facilitates the rolling of the droplets g1 of liquid Lq on the detection surface 20. In one non-limiting example, the surface tension γ3 is equal to 78 mJ/m2 (millijoules/square meter). In one non-limiting example, the surface tension γ1 is equal to 20 mJ/m2 (millijoules/square meter) for a hydrophobic surface. It will be noted that a window washer liquid has a surface tension (30 mJ/m2) relatively close to the surface tension γ1 of the detection surface 20. The droplets g1 of liquid Lq therefore roll with greater difficulty. In the remainder of the description, the droplets g1 of liquid Lq are otherwise referred to as droplets g1.

The cleaning device 10 of the cleaning system 1 is now described in detail below.

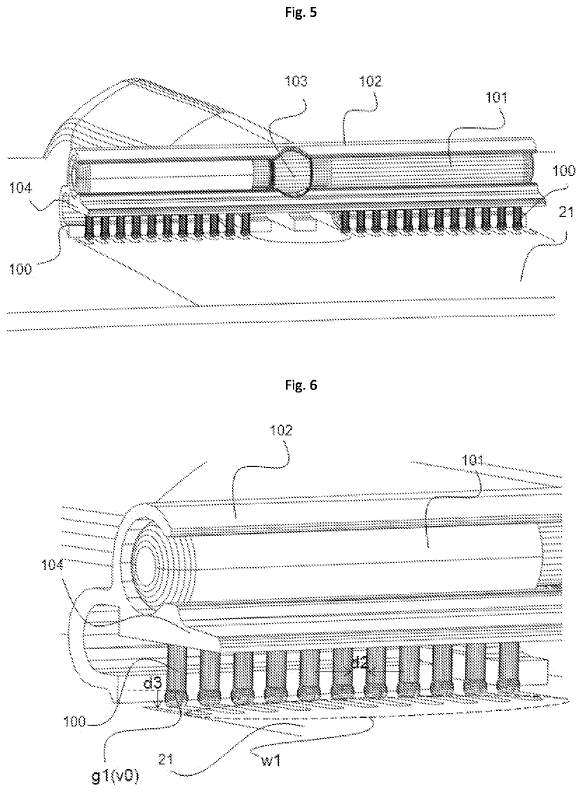

As illustrated in FIG. 2, the cleaning device 10 is placed at a distance from the surface to be cleaned 20. Moreover, as illustrated in FIG. 2 and FIG. 5, the cleaning device 10, notably its nozzles 100 described below, is placed above an acceleration surface 21 so as to allow it to deposit the droplets g1 of liquid Lq on said acceleration surface 21.

The acceleration surface 21 is a surface on which droplets g1 of liquid Lq will be deposited by the nozzles 100 of the cleaning device 10 and accelerated by the acceleration device 12 described below. The acceleration surface 21 is situated upstream of the detection surface 20 with respect to the field of view of the sensor 2. “Upstream” is understood to mean that the acceleration surface 21 is situated before the detection surface 20 in the propagation direction of the liquid Lq. In one non-limiting embodiment, the acceleration surface 21 has a surface tension γ2 different from the surface tension γ1 of said detection surface 20. This makes it possible to obtain rolling angles of greater than 80°, or even greater than 90° or 160°, for droplets g1 of liquid Lq.

In one non-limiting embodiment illustrated in FIG. 2, the detection surface 20 and the acceleration surface 21 are on the same plane. This allows the droplets g1 of liquid Lq to slide more easily and to thus discharge the obstructing elements g2 more easily.

In one non-limiting embodiment, the detection surface 20 and the acceleration surface 21 are inclined by an angle of inclination greater than 20° with respect to a reference axis. In one non-limiting embodiment variant, the detection surface 20 and the acceleration surface 21 are inclined by an angle of inclination of between 20° and 30° with respect to a reference axis. In one non-limiting example, this applies to a vehicle sensor 2 such as a camera situated in the region of the rear windshield. In this case, the reference axis is the vehicle axis.

In one non-limiting embodiment, the detection surface 20 and the acceleration surface 21 are horizontal. In one non-limiting example, this applies to a building sensor 2 such as a solar collector or photovoltaic sensor.

It will be noted that in these cases of inclinations between 20° and 30° or of no inclination, the detection surface 20 and the acceleration surface 21 are not sufficiently inclined in order for the obstructing elements g2, notably when they are static, to be driven naturally outside of the detection surface 20 by gravity.

In the case of an angle of inclination higher than 30°, the obstructing elements g2 would be able to be discharged naturally by gravity. However, discharging by gravity takes a long time, and this hinders the detection function of the sensor 2, or even renders it ineffective, during this discharge time, otherwise referred to as dead time. Furthermore, the natural discharge by gravity is not very effective and residues of obstructing elements g2 still remain.

In a first non-limiting embodiment, the detection surface 20 and the acceleration surface 21 do not form part of the sensor 2. Thus, the cleaning system 1 (notably the cleaning device 10 and the acceleration device 12) is situated at a distance from the sensor 2 and notably from the surface to be cleaned 20. The nozzles 100 deposit droplets g1 on a surface outside the sensor 2. In one non-limiting example, this applies when a sensor 2 is a vehicle sensor such as a camera which is situated behind the rear windshield of said vehicle. In order to avoid hindering visibility for the driver, the cleaning system 1 is not positioned directly in the vicinity of the camera 2, but rather further away upstream of the camera 2 at a distance referred to as dead zone. The cleaning system 1 is then situated on the windshield at the outside or on the body high up with respect to the camera 2. The acceleration surface 21 thus forms part of the windshield or of the body in this case, and the detection surface 20 forms part of the windshield.

In a second non-limiting embodiment, said detection surface 20 and the acceleration surface 21 form part of the sensor 2. Thus, the sensor 2 comprises the detection surface 20, namely the surface to be cleaned, and the acceleration surface 21. Thus, the cleaning system 1 (notably the cleaning device 10 and the acceleration device 12) is situated in the vicinity of the surface to be cleaned 20. The nozzles 100 deposit droplets g1 on a surface portion of the sensor 2. In one non-limiting example, this applies when a sensor 2 is a building sensor such as a solar collector or a photovoltaic sensor. In one non-limiting embodiment, the total surface formed by the detection surface 20 and the acceleration surface 21 of the sensor 2 is substantially rectangular. In one non-limiting embodiment, the total surface is between 100 mm and 1500 mm. In this case, in one non-limiting embodiment, a portion of the acceleration surface 21 may also be partially coincident with a portion of the detection surface 20. This means that the droplets g1 of liquid Lq can be accelerated onto a portion of the detection surface 20.

In a third non-limiting embodiment, said detection surface 20 forms part of the sensor 2 and the acceleration surface 21 does not form part of the sensor 2. Thus, the sensor 2 comprises the detection surface 20, namely the surface to be cleaned, but not the acceleration surface 21. Thus, the cleaning system 1 (notably the cleaning device 10 and the acceleration device 12) is situated in the vicinity of the surface to be cleaned 20. The nozzles 100 deposit droplets g1 on a surface outside the sensor 2.

As illustrated in FIGS. 1 to 8, the cleaning device 10 comprises a plurality of nozzles 100.

In non-limiting embodiments, the cleaning device 10 further comprises:
a perforated bar 101,
a support element 102 for said perforated bar 101,
a water distributor 103,
a protruding element 104 for the perforated bar 101.

In one non-limiting embodiment, the cleaning device 10 further comprises an attachment element 105.

The elements of the cleaning device 10 are described in detail below.

The nozzles 100 are configured to generate and deposit droplets g1 of liquid Lq on the acceleration surface 21 of the sensor 2, said acceleration surface being situated upstream of said detection surface 20.

In one non-limiting embodiment, the droplets g1 have a volume v0 of between 2 μL and 50 μL (microliters). This makes it possible to have droplets g1 that are sufficiently small so as to limit the consumption of liquid Lq, and that are sufficiently large so that they can roll on the acceleration surface 21 and on the detection surface 20. They will have a sufficient rolling angle.

In one non-limiting embodiment, the nozzles 100 are configured to deposit a droplet g1 at a pressure of less than or equal to 0.5 bar. The nozzles 100 thus operate at low pressure, making it possible to control the production of the droplets g1 and the deposition of the droplets g1 on the acceleration surface 21. If the pressure is too great, there would be a jet of liquid Lq instead of formation of a droplet g1 of liquid Lq.

In one non-limiting embodiment, the nozzles 100 have a diameter d1 of between 0.5 mm and 6 mm (millimeters). It will be noted that with a diameter d1 of 0.5 mm, it is possible to create droplets g1 of 6 mm.

In one non-limiting embodiment, the nozzles 100 are spaced apart from one another such that the deposited droplets g1 form a water front w1 (otherwise referred to as wave front and illustrated in FIG. 6). In one non-limiting embodiment variant, the nozzles 100 are spaced apart by a distance d2 (illustrated in FIG. 6) equal to the diameter d0 of the droplets g1 plus or minus 10%. This water front w1 is a fusion of droplets g1 which is created after said droplets g1 have been deposited on the acceleration surface 21 and will allow the entire surface to be cleaned, namely the detection surface 20, to be covered more effectively. Combined with the range for the diameter d0 of 2 μl and 50 μl, this makes it possible to obtain coalescence of the droplets g1 such that they merge into larger droplets so as to form a water front w1.

Furthermore, the nozzles 100 are disposed at a distance d3 (illustrated in FIG. 6) from the acceleration surface 21 of between 0 and 100% of the diameter d0 of the droplets g1. The nozzles 100 are thus calibrated as a function of the diameter d0 of the droplets g1. They are close to the acceleration surface 21. This distance d3 is the distance between the bottom of the nozzles 100 and the acceleration surface 21. This allows the droplets g1 to detach from the nozzles 100. At 0%, the droplet g1 is in contact with the nozzle 100 and at the same time with the acceleration surface 21. At 100%, the droplet g1 is no longer in contact with the nozzle 100 when it is in contact with the acceleration surface 21. If the distance d3 is greater than 100% of the diameter d0, then the distance d3 is too great, the droplet g1 will gain speed upon exiting the nozzle 100 before exploding and dividing into several small droplets on the acceleration surface 21. While the small droplets will slide on the detection surface 20 and will entrain the obstructing elements g2, there will still be areas between the small droplets where the detection surface 20 will not be cleaned. There will therefore still be traces on the detection surface 20, thus hindering the sensor 2 from performing its detection function.

The perforated bar 101 comprises orifices (not illustrated) in which the nozzles 100 are inserted.

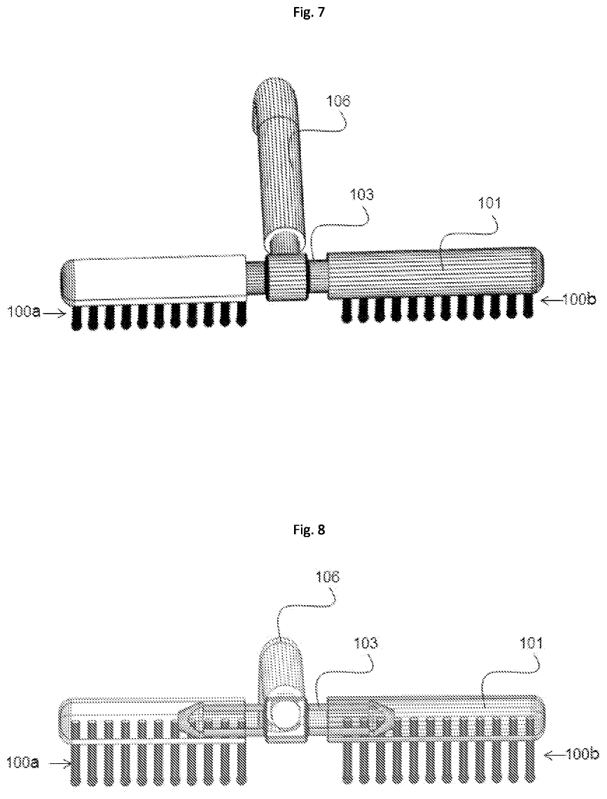

As illustrated in FIG. 7 and FIG. 8, in one non-limiting embodiment, the perforated bar 101 and the nozzles 100 form only a single component for sealing reasons. The perforated bar 101 is connected on one side to the nozzles 100 and on the other side to the tank 11 via a connecting tube 106 illustrated in FIG. 7 and FIG. 8.

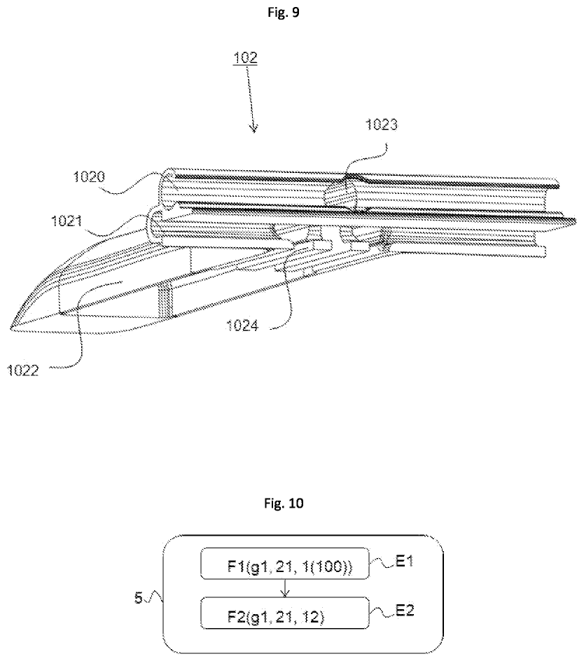

As illustrated in FIG. 9, the support element 102 for said bar 101 comprises a cavity 1020 in which said bar 101 can be inserted. The cavity 1020 is longitudinal.

In one non-limiting embodiment, the support element 102 for said bar 101 is also configured to receive the acceleration device 12. To this end, in one non-limiting embodiment, the support element 102 comprises an additional cavity 1021 in which the acceleration device 12 can be inserted. This is the case when the acceleration device 12 comprises an air flow-projection device as described below. As illustrated in FIG. 9, in one non-limiting embodiment variant, the additional cavity 1021 is disposed below the cavity 1020 and facing the nozzles 100.

In one non-limiting embodiment, the support element 102 further comprises a protective cover 1022 configured to protect the connecting tube 106 described above.

In one non-limiting embodiment, the support element 102 further comprises an orifice 1023 in which the water distributor 103 can be inserted in order to be connected to the connecting tube 106, as illustrated in FIG. 7. This orifice 1023 opens out onto the cavity 1020.

In one non-limiting embodiment, the support element 102 further comprises a bearing element 1024 configured to bear against a support 3 (illustrated in FIG. 2) on which said cleaning device 10 will be placed. In the non-limiting example illustrated in FIG. 9, said bearing element 1024 is composed of two bearing tabs.

As illustrated in FIG. 7 and FIG. 8, the water distributor 103 is configured to distribute the liquid Lq to the nozzles 100. The bar 101 is thus connected to the tank 11 via the water distributor 103. In one non-limiting embodiment, the water distributor 103 is connected to the tank 11 via the connecting tube 106.

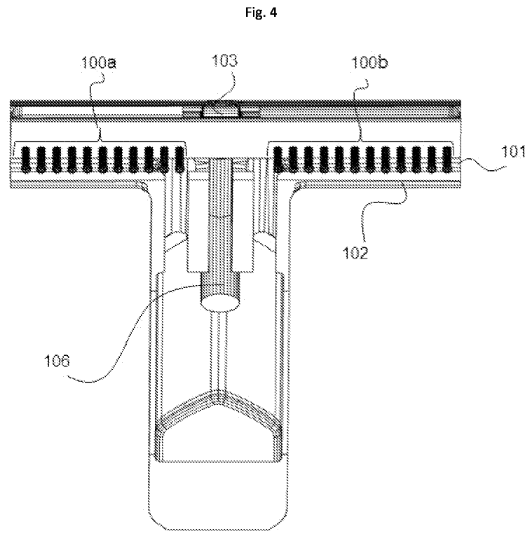

In order to obtain a water front w1 as described above, in one non-limiting embodiment, the distribution of liquid Lq in the nozzles 100 is effected in a homogeneous and continuous manner for a limited period of time. Homogeneous is understood to mean that the distribution of liquid Lq allows droplets g1 of the same size to be created for all the nozzles 100 simultaneously. Continuous is understood to mean that the distribution of liquid Lq allows droplets g1 to be created one after the other by a nozzle 100. The limited period of time allows the consumption of liquid Lq to be reduced. In one non-limiting embodiment, the period of time is 0.5 second. This makes it possible to create a water front w1 or a line of droplets g1. In one non-limiting embodiment, in order to have a homogeneous and continuous distribution, the water distributor 103 is disposed between two sets 100a and 100b (illustrated in FIG. 4, FIG. 7 and FIG. 8, for example) of nozzles 100 distributed in a symmetrical manner on either side of the water distributor 103. In one non-limiting embodiment, the water distributor 103 is in the form of a T. It will be noted that if the water distributor 103 were to be disposed at an end of the bar 101 and not in the middle, there would be a risk of the distribution of water being discontinuous and inhomogeneous. Inhomogeneous is understood to mean a distribution that is not distributed evenly, since the nozzles 100 that are closest would receive more liquid Lq than the nozzles 100 that are furthest away, and this could create differences in size between the droplets g1 created.

In one non-limiting embodiment, in order to create injection sequences for droplets g1, the cleaning system 1 may further comprise an electrovalve (not illustrated) for controlling the opening time of the water distributor 103. There will thus be a limited period of time for distributing water.

As illustrated in FIG. 5 and FIG. 6, the protruding element 104 for said bar 101 is configured to protect the acceleration surface 21 from external attacks such as, in non-limiting examples, dirt, wind, etc. In one non-limiting embodiment, the protruding element 104 and the support element 102 form only a single component. The protruding element 104 extends above the nozzles 100.

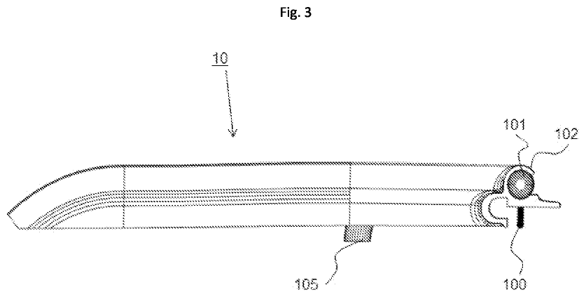

As illustrated in FIG. 3, the attachment element 105 is configured to attach the cleaning device 10 to a support 3 (illustrated in FIG. 2) which either forms part of the sensor 2 or is independent of the sensor 2. Thus, in the case of a sensor 2 for a vehicle, in one non-limiting example, the support 3 is the body of the vehicle or the windshield of the vehicle. Thus, in the case of a sensor 2 for a building, such as a solar collector or a photovoltaic sensor, in one non-limiting example, the support 3 is the structure of said sensor 2. In one non-limiting example, the attachment element 105 is a screw.

The acceleration device 12 of the cleaning system 1 is now described in detail below.

The acceleration device 12 is configured to accelerate the movement of the droplets g1 of liquid Lq from said acceleration surface 21 onto said detection surface 20. This makes it possible to entrain obstructing elements g2 such as, in one non-limiting example, static dirt or static water droplets located on the detection surface 20, and to thus discharge them from said detection surface 20. With these droplets g1, the flow of the obstructing elements g2, which could occur naturally by gravity, is thus accelerated so as to rapidly clear the detection surface 20, which is the detection surface of the sensor 20, of the obstructing elements g2.

The advantages of such an acceleration of the droplets g1 are described below.

By accelerating the droplets g1, the cleaning time for the detection surface 20 is thus reduced. The dead time that may exist when the sensor 2 performs its detection function, dead time due to the obstructing elements g2 that hinder said detection function, is thus reduced.

Moreover, it will be noted that the viscosity of the droplets g1 changes with the temperature. It increases when it is cold. By accelerating the droplets g1 instead of allowing them to roll naturally on the acceleration surface 21 and then on the detection surface 20, external factors such as the temperature or the wind are overcome. Specifically, without acceleration, if it is too cold, the droplets g1 risk not flowing fast enough on the acceleration surface 21 and then on the detection surface 20 and thus risk not entraining the obstructing elements g2 sufficiently in such a way as to discharge them from the detection surface 20.

Furthermore, by accelerating the droplets g1, the surface state of the detection surface 20 is overcome. Specifically, if the detection surface 20 is not hydrophobic enough, the droplets g1 will have difficulty rolling naturally by gravity on the detection surface 20 and will have difficulty entraining the obstructing elements g2 effectively.

Lastly, by accelerating the droplets g1, the angle of inclination of the detection surface 20 is overcome. Specifically, if the angle of inclination is less than 20%, the droplets g1 will have difficulty rolling naturally by gravity on the detection surface 20 and will have difficulty entraining the obstructing elements g2 effectively.

Thus, the acceleration of the droplets g1 makes it possible to provide them with enough kinematic energy to roll properly on the acceleration surface 21 and on the detection surface 20, and to thus entrain the obstructing elements g2 effectively in such a way as to discharge them from the detection surface 20.

The acceleration device 12 is described according to various non-limiting embodiments below.

In a first non-limiting embodiment illustrated in FIG. 1 and FIG. 6, the acceleration device 12 is an air flow-projection device. The air flow-projection device is thus a fan. The air flow is directed onto the droplets g1 so as to accelerate them. In one non-limiting example, the air flow-projection device is placed in the additional cavity 1021 of the support element 102 for the bar 101 described above.

In a second non-limiting embodiment that is not illustrated, the acceleration device 12 is a device composed of a grid of electrodes that is configured to be passed through by an electrical current. The electrical current is alternating current. This creates an inchworm motion for the droplets g1 so as to accelerate their movement. The droplets g1 are thus rendered hydrophilic. This grid of electrodes is integrated into the acceleration surface 21.

In a third non-limiting embodiment, the acceleration device 12 is a device configured to create a Leidenfrost effect by heating the acceleration surface 21. The Leidenfrost effect is the phenomenon which induces calefaction of a droplet of a liquid on a hot plate. Thus, instead of boiling violently and vaporizing, the droplets g1 adopt a very rounded shape and become ultra-mobile. In one non-limiting example, the acceleration surface 21 is heated to more than 160°. The acceleration device 12 is placed in the region of the acceleration surface 21. In one non-limiting example, the acceleration device 12 is a flexible substrate comprising piezoelectric elements. In another non-limiting example, the acceleration device 12 is composed of thermo-resistors.

In a fourth non-limiting embodiment, the acceleration device 12 is a device configured to synthesize an ultrasonic wave propagating in the acceleration surface 21. The device comprises at least one wave transducer acoustically coupled to the acceleration surface 21. This device allows the liquid to be set in motion and accelerated on the acceleration surface 21 under the action of the ultrasonic wave. The liquid takes the form of very rounded and therefore ultra-mobile droplets g1. This thus allows the detection surface 20 to be cleaned in a simple and effective manner when these droplets g1 travel across it.

In one non-limiting example, the acceleration device 12 is a device configured to synthesize an ultrasonic wave propagating in the acceleration surface 21 and in the detection surface 20. The device comprises at least one wave transducer acoustically coupled to the acceleration surface 21 and to the detection surface 20. The liquid takes the form of very rounded and therefore ultra-mobile droplets g1 on the acceleration surface 21. Notably, setting the liquid in motion and accelerating it under the action of the ultrasonic wave on the acceleration surface 21 facilitates the spreading of the liquid, of the layer formed by the liquid, on the detection surface 20. It also makes it possible to effectively discharge the dirty water from the detection surface. The droplets of dirty liquid clinging to the detection surface under the action of capillary forces can easily be discharged.

In a fifth non-limiting embodiment, the acceleration device 12 is a device composed of particles of different polarities. The acceleration device 12 is integrated into the acceleration surface 21, namely it is the acceleration surface 21 which is composed of particles of different polarities. Upon contact with the acceleration surface 21, the droplets g1 polarize; the polarization causes small bounces of the droplets g1, resulting in accelerations of said droplets g1.

Thus, the cleaning system 1 is configured to implement a method 5 for cleaning a detection surface 20 of a sensor 2. The cleaning method 5 is illustrated in FIG. 10 and thus comprises the steps:
E1, illustrated F1(g1, 21, 1(100)), depositing droplets g1 of liquid Lq on an acceleration surface 21 situated upstream of said detection surface 20 by means of a plurality of nozzles 100 of a cleaning device 10,
E2, illustrated F2(g1, 21, 12), accelerating the movement of said droplets g1 of liquid Lq from said acceleration surface 21 onto said detection surface 20 by means of an acceleration device 12.

Of course, the description of the invention is not limited to the embodiments described above and to the field described above. Thus, in one non-limiting embodiment, the total surface 22 formed by the detection surface 20 and the acceleration surface 21 is curved. Thus, in one non-limiting embodiment, the total surface 22 is oval or round. Thus, in another non-limiting embodiment, the sensor 2 is a light emitter such as, in one non-limiting example, a headlamp. Thus, in the description, a non-limiting example of a sensor 2 situated behind the rear windshield of a vehicle has been given. However, in another non-limiting embodiment, it is of course also possible for the cleaning system 1 to be applied to a sensor 2 situated behind the front windshield of a vehicle.

Thus, the invention described notably has the following advantages:
it makes it possible for a detection surface 20 of the sensor 2 to be cleaned effectively by combining the use of droplets g1 of liquid Lq and an acceleration of said droplets g1,
it makes it possible to effectively replace a solution that uses only an air flow-projection device, of which the air flow alone is not effective if the obstructing elements g2 are too small,
it is effective irrespective of the size of the obstructing elements g2,
it makes it possible to treat large surfaces contrary to a rotary solution using centrifugal force to eliminate the obstructing elements g2,
it makes it possible to avoid having vibratory components contrary to a solution using ultrasound to eliminate the obstructing elements g2; it is a solution applicable to polymer components,
it makes it possible to address the same size of sensors 2 as for the other solutions used,
the cleaning system 1 can be placed at a distance from the sensor 2, and notably from its detection surface 20, so as to allow good integration of the cleaning system 1 in a vehicle,
it is a solution which adapts to vehicle sensors 2 located, for example, behind the rear or front windshield, such as a camera, windshield that is unable to receive a cleaning system in the vicinity of said sensor 2 but only at a distance therefrom; it is a less bulky solution than one or more air flow-projection devices that would have to be used in this case in order to be able to generate an air flow that is powerful enough to travel the distance separating it from said sensor 2 so as to clean the latter.

What is claimed is:

1. A system for cleaning a detection surface of a sensor, comprising:
a cleaning device including a plurality of configured to deposit droplets of liquid on an acceleration surface situated upstream of the detection surface,
a tank connected to the cleaning device and configured to store the liquid, and
a device for accelerating the movement of the droplets of liquid from the acceleration surface onto the detection surface.

2. The cleaning system as claimed in claim 1, wherein the droplets have a volume of between 2 μL and 50 μL.

3. The cleaning system as claimed in claim 1, wherein the liquid has a surface tension greater than a surface tension of the detection surface.

4. The cleaning system as claimed in claim 1, wherein the nozzles are spaced apart from one another such that the droplets form a water front.

5. The cleaning system as claimed in claim 1, further comprising a perforated bar connected on one side to the nozzles and on another side to the tank.

6. The cleaning system as claimed in the preceding claim 5, further comprising a support element for the perforated bar.

7. The cleaning system as claimed in claim 1, wherein the acceleration device is:
an air flow-projection device, or
a device composed of a grid of electrodes that is configured to be passed through by an electrical current, or
a device configured to create a Leidenfrost effect, or
a device configured to synthesize an ultrasonic wave propagating in the acceleration surface, or
a device composed of particles of different polarities.

8. An assembly comprising a detection surface of a sensor and a cleaning system, with the cleaning system including a cleaning device with a plurality of nozzles configured to deposit droplets of liquid on an acceleration surface situated upstream of the detection surface, a tank connected to the cleaning device and configured to store the liquid, and a device for accelerating the movement of the droplets of liquid from the acceleration surface onto the detection surface.

9. The assembly as claimed in claim 8, wherein the sensor is an optical sensor.

10. The assembly as claimed in claim 8, wherein:
the detection surface and the acceleration surface form part of the sensor, or
the detection surface and the acceleration surface do not form part of the sensor.

11. The assembly as claimed in claim 8, wherein the detection surface and the acceleration surface are on the same plane.

12. The assembly as claimed in claim 8, wherein a portion of the detection surface is partially coincident with a portion of the acceleration surface.

13. A method for cleaning a detection surface of a sensor for a vehicle, comprising:
depositing droplets of liquid on an acceleration surface of the sensor, the acceleration surface being situated upstream of the detection surface, by means of a plurality of nozzles of a cleaning device,
accelerating the movement of the droplets of liquid from the acceleration surface onto the detection surface by means of an acceleration device.
